(19) United States
(12) Patent Application Publication
(10) Pub. No.: US 2026/0338579 A1
(43) Pub. Date: Oct. 29, 2026

(54) MAP AREA DIVISION METHOD, SELF-PROPELLED DEVICE AND COMPUTER-READABLE MEDIUM

(71) Applicant: JIANGSU DONGCHENG M&E TOOLS CO., LTD., Nantong (CN)

(72) Inventor: Jinqiao LEI, Nantong (CN)

(73) Assignee: JIANGSU DONGCHENG M&E TOOLS CO., LTD., Nantong (CN)

(21) Appl. No.: 19/117,650

(22) PCT Filed: Aug. 26, 2024
(86) PCT No.: PCT/CN2024/114467

§ 371 Date: Apr. 2, 2025

(30) Foreign Application Priority Data
Sep. 26, 2023 (CN) 202311262890.9

(51) Int. Cl. G01C 21/00; A01D 34/00; A01D 101/00

(52) U.S. Cl. CPC G01C 21/3859; A01D 34/008; A01D 2101/00

(57) ABSTRACT

A map area division method, a self-propelled device and a computer-readable medium are provided. The map area division method includes: constructing a map of an operation area of the self-propelled device, and obtaining an outer boundary map; obtaining concave points in the outer boundary map; determining concave-point pairs according to visibility of the concave points, and performing an optimal segmentation according to a relationship between the connection lines of the visible concave-point pairs; The connection lines of the concave-point pairs for the optimal segmentation do not intersect with each other. In the present disclosure, the operation area map of a self-propelled device may be segmented according to the outer boundary.

### CROSS REFERENCE TO RELATED APPLICATIONS

This application is a 35 U.S.C. § 371 National Phase conversion of International Patent Application No. PCT/CN2024/114467, filed Aug. 26, 2024, which claims the priority of Chinese Patent Application No. 202311262890.9 filed Sep. 26, 2023, both of which are herein incorporated by reference in their entireties.

### TECHNICAL FIELD

The present disclosure relates to the technical field of area division technologies for a self-propelled device, in particular to a map area division method for the self-propelled device and a map area division system for the self-propelled device.

### BACKGROUND

The operation area division for a self-propelled device is a critical constitutional part of the self-propelled device technology. In an actual operation process, due to irregularity of an original map, there are several concave corners, which may lead to too many turning operations or stuck of the self-propelled device, thereby reducing the operation efficiency. Therefore, by reasonably dividing the area of the map of the self-propelled device and eliminating the concave corners, the operation efficiency of the self-propelled device may be significantly enhanced.

In the related art, several map area division algorithms already exist. However, these algorithms have the following problems: 1) these algorithms have not been applied to the technical field of self-propelled devices, and may need to be modified in conjunction with actual scenarios; 2) these algorithms cannot meet actual application requirements, and it is unreasonable to directly apply the divided areas; 3) these algorithms may only be applied to a part of the scenarios, and the current technology cannot directly handle another part of the scenarios.

### SUMMARY

According to a first aspect of the present disclosure, a map area division method is provided. The map area division method is applied to a self-propelled device. The map area division method includes: obtaining an outer boundary map of an operation area of the self-propelled device; obtaining concave points in the outer boundary map; and determining concave-point pairs according to visibility of the concave points, and performing an optimal segmentation of the operation area according to a relationship between connection lines of the concave-point pairs. The connection lines of the concave-point pairs for the optimal segmentation do not intersect with each other.

In some embodiments, the obtaining an outer boundary map of an operation area of the self-propelled device includes: the self-propelled device walking along the outer boundary of the operation area to obtain a coordinate of each point along the outer boundary, and constructing the outer boundary map.

In some embodiments, the obtaining the concave point in the outer boundary map includes: recognizing inflection points in the outer boundary map, and obtaining feature points from the recognized inflection points; and recognizing concave points from the obtained feature points.

In some embodiments, the method further includes: comparing adjacent coordinate points in the outer boundary map; and recognizing inflection points from the two adjacent coordinate points, when the two adjacent coordinate points are in the same row but with different column coordinates, or in the same column but with different row coordinates.

In some embodiments, the method further includes: obtaining a feature point serves as a concave point, when an included angle of the feature point is greater than 180 degrees, wherein the included angle is inside the map and is formed by outer boundary lines on both sides of the feature point.

In some embodiments, the method further includes: matching the visible concave points two by two to obtain visible concave-point pairs; wherein a connection line of the two visible concave points is entirely inside the map.

In some embodiments, the method further includes: performing a single-point segmentation on the concave points when the optimal segmentation is unable to be performed.

In some embodiments, a single-point segmentation line for performing the single-point segmentation does not intersect with an optimal segmentation line for performing the optimal segmentation.

According to another aspect of the present disclosure, a self-propelled device is provided. The self-propelled device includes a processor and a memory. The memory stores at least one instruction. The at least one instruction may be loaded by the processor and implement the following operations: obtaining an outer boundary map of an operation area of the self-propelled device; obtaining concave points in the outer boundary map; and determining concave-point pairs according to visibility of the concave points, and performing an optimal segmentation of the operation area according to a relationship between connection lines of the concave-point pairs. The connection lines of the concave-point pairs for the optimal segmentation do not intersect with each other.

In some embodiments, the obtaining an outer boundary map of an operation area of the self-propelled device includes: the self-propelled device walking along the outer boundary of the operation area to obtain a coordinate of each point along the outer boundary, and constructing the outer boundary map.

In some embodiments, the obtaining the concave points in the outer boundary map includes: recognizing inflection points in the outer boundary map, and obtaining feature points from the recognized inflection points; and, recognizing concave points from the obtained feature points.

In some embodiments, the method further includes: obtaining a feature point serves as a concave point, when an included angle of the feature point is greater than 180 degrees, wherein the included angle is inside the map and is formed by outer boundary lines on both sides of the feature point.

In some embodiments, the method further includes: matching the visible concave points two by two to obtain visible concave-point pairs; wherein a connection line of the two visible concave points is entirely inside the map.

In some embodiments, the method further includes: performing a single-point segmentation on the concave points when the optimal segmentation is unable to be performed. A single-point segmentation line for performing the single-point segmentation does not intersect with an optimal segmentation line for performing the optimal segmentation.

According to another aspect of the present disclosure, a non-transitory computer-readable storage medium is provided. The storage medium stores at least one instruction. The at least one instruction is loaded by the processor, and is configured to perform the following operations: obtaining an outer boundary map of an operation area of the self-propelled device; obtaining concave points in the outer boundary map; and determining concave-point pairs according to visibility of the concave points, and performing an optimal segmentation of the operation area according to a relationship between connection lines of the concave-point pairs. The connection lines of the concave-point pairs for the optimal segmentation do not intersect with each other.

In some embodiments, the obtaining an outer boundary map of an operation area of the self-propelled device includes: the self-propelled device walking along the outer boundary of the operation area to obtain a coordinate of each point along the outer boundary, and constructing the outer boundary map.

In some embodiments, the obtaining the concave point in the outer boundary map includes: recognizing inflection points in the outer boundary map, and obtaining feature points from the recognized inflection points; and recognizing concave points from the obtained feature points.

In some embodiments, the method further includes: obtaining a feature point serves as a concave point, when an included angle of the feature point is greater than 180 degrees, wherein the included angle is inside the map and is formed by outer boundary lines on both sides of the feature point.

In some embodiments, for any two concave points, matching the visible concave points two by two to obtain visible concave-point pairs; wherein a the connection line of the two visible concave points is entirely inside the map.

In some embodiments, the method further includes: performing a single-point segmentation on the concave points when the optimal segmentation is unable to be performed. A single-point segmentation line for performing the single-point segmentation does not intersect with an optimal segmentation line for performing the optimal segmentation.

### BRIEF DESCRIPTION OF THE DRAWINGS

In order to more clearly illustrate technical solutions in the present disclosure, the drawings required in the description of the embodiments will be briefly introduced below. Obviously, the drawings in the following description are only some embodiments of the present disclosure. For those of ordinary skills in the art, other drawings could be obtained based on these drawings without creative efforts.

FIG. 1 is a flow chart of a map area division method for a self-propelled device according to some embodiments of the present disclosure.

FIG. 2 is a schematic diagram of recognized inflection points and concave points according to some embodiments of the present disclosure.

FIG. 3 is a schematic diagram of visibility of concave-point pairs according to some embodiments of the present disclosure.

FIG. 4 is a schematic diagram of an optimal segmentation according to some embodiments of the present disclosure.

FIG. 5 is a schematic diagram of two optimal segmentation lines that do not intersect with each other according to some embodiments of the present disclosure.

FIG. 6 is a schematic diagram of two segmentation lines that intersect with each other and processing of the intersecting segmentation lines according to some embodiments of the present disclosure.

FIG. 7 is a schematic diagram of two single-point segmentation lines that do not intersect with each other according to some embodiments of the present disclosure.

FIG. 8 is a schematic diagram of processing of two single-point segmentation lines that intersect with each other according to some embodiments of the present disclosure.

FIG. 9 is a schematic diagram of a case in which an angular bisector for segmentation intersects with a single-point segmentation line according to some embodiments of the present disclosure.

FIG. 10 is a schematic structural diagram of a map area division system for a self-propelled device according to some embodiments of the present disclosure.

### DETAILED DESCRIPTION

To clarify the purposes, the technical solutions and advantages of the embodiments of the present disclosure, the technical solutions of the present disclosure will be clearly and comprehensively described below in conjunction with the drawings of the present disclosure. The embodiments described are obviously a part of the embodiments of the present disclosure, not all of them. All other embodiments, that are obtained by those of ordinary skills in the art based on the described embodiments of the present disclosure and without creative efforts, would fall within the protection scope of the present disclosure.

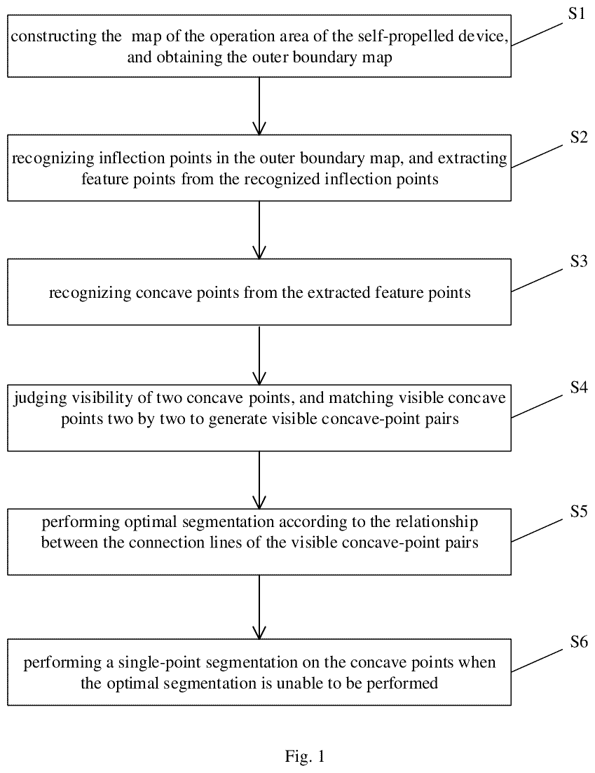

The present disclosure provides a map area division method for a self-propelled device. The self-propelled device may be a device with self-mobile function, such as a lawn mower, a sweeping robot, or the like. The method may include operations at blocks as illustrated in FIG. 1.

In an operation at block S1: constructing a map of an operation area of the self-propelled device, and obtaining an outer boundary map.

As an alternative embodiment, the outer boundary map is marked by a plurality of coordinate points. The self-propelled device walks and performs locating along the outer boundary of the operation area, obtains the coordinates of each point on the outer boundary, and establishes the outer boundary map.

In an operation at block S2: recognizing inflection points in the outer boundary map, and extracting feature points from the recognized inflection points.

As an alternative embodiment, when recognizing the inflection points, comparing adjacent coordinate points along the outer boundary. In a case where the two adjacent coordinate points are on the same row but their column coordinate values differ, or in a case where the two adjacent coordinate points are on the same column but their row coordinate values differ, then it is considered that an inflection point exists.

Taking a certain inflection point as a starting point, retaining only one inflection point for every n Manhattan distances, thereby extracting the feature points.

In an operation at block S3: recognizing concave points from the extracted feature points.

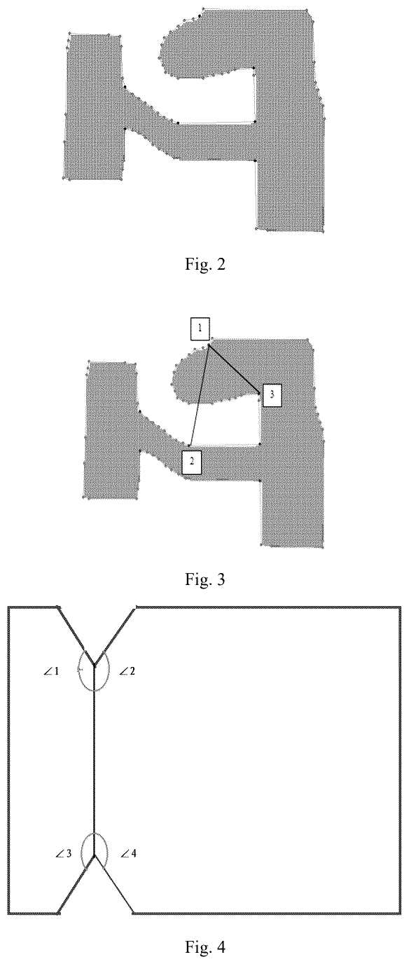

Among the extracted feature points, in a case where an included angle is greater than 180 degrees, and the included angle is inside the map and formed by outer boundary lines on both sides of a certain feature point, this certain feature point is recognized as a concave point, and the included angle matching the concave point is recognized as a concave angle. As illustrated in FIG. 2, a black dot represents a recognized concave point. The lines on both sides of the black dot represent a concave angle. In other words, the concave angle is an angle being greater than 180 degrees inside a map.

In an operation at block S4: judging visibility of two concave points, and matching visible concave points two by two to generate visible concave-point pairs.

For any two concave points, drawing a connection line from one of two concave points to another of the two concave points. In a case where this connection line is entirely inside the map, then these two concave points are visible to each other. In a case where this connection line is not entirely inside the map, these two concave points are invisible to each other. Matching visible concave points two by two to generate visible concave-point pairs.

As illustrated in FIG. 3, point 1 and point 2 are invisible, point 1 and point 3 are visible.

In an operation at block S5: performing optimal segmentation according to a relationship between the connection lines of the visible concave-point pairs.

The definition of the optimal segmentation is as follows: in a case where the connection lines of the visible concave-point pairs do not generate a new concave angle, this connection line segmentation is considered as the optimal segmentation.

The operation at the block S5 specifically includes the following operations S51 to S54.

Operation S51: connecting an arbitrary visible concave-point pair for an optimal segmentation, and forming a first optimal segmentation line.

FIG. 4 is a schematic diagram of an optimal segmentation. In a case where each of ∠1, ∠2, ∠3, and ∠4 is less than 180 degrees, this segmentation line forms the optimal segmentation line. In a case where either of ∠1, ∠2, ∠3, and ∠4 is not less than 180 degrees, this segmentation line is not the optimal segmentation line.

Operation S52: in a case where a next optimal segmentation line does not intersect with the first optimal segmentation line, then this segmentation is valid.

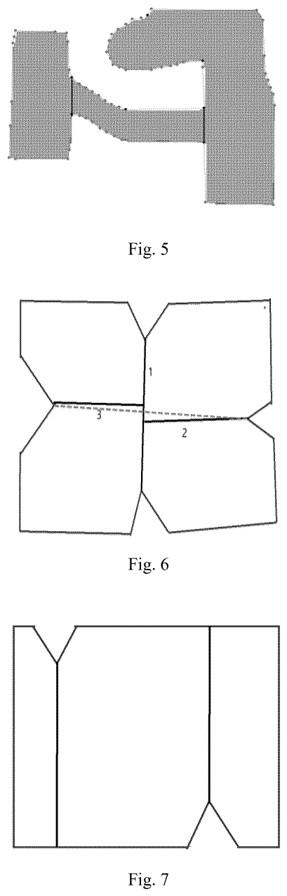

As illustrated in FIG. 5, in a case where the second optimal segmentation line does not intersect with the first optimal segmentation line, both the first optimal segmentation line and the second optimal segmentation line (the black lines in FIG. 5) are valid.

Operation S53: in a case where the next optimal segmentation line intersects with the first optimal segmentation line, drawing a perpendicular line from each of two concave points of a concave-point pair to an existing optimal segmentation line that intersects with the next optimal segmentation line first. Taking this perpendicular line as a segmentation line.

As illustrated in FIG. 6, the dotted line is an optimal segmentation line that intersects with another optimal segmentation line 1. At this point, a perpendicular line 2 is drawn from one of the two concave points to the existing optimal segmentation line 1, a perpendicular line 3 is drawn from another one of the two concave points to the existing optimal segmentation line 1. The perpendicular lines 2 and 3 are taken as the segmentation lines.

Operation S54: after the segmentation process for a concave point is completed, the concave point is deleted from the visible concave-point pairs.

In an operation at block S6: performing a single-point segmentation on the concave points when the optimal segmentation is unable to be performed.

The process in which performing a single-point segmentation on the concave points when the optimal segmentation is unable to be performed specifically includes the following operations S61 to S65.

Operation S61: drawing a perpendicular line from this concave point to a boundary line that is on a side opposite to this concave point and visible to the concave point. In a case where two new angles generated after the concave angle matching the concave point is segmented are both less than 180 degrees, taking this perpendicular line as a single-point segmentation line.

Operation S62: in a case where the single-point segmentation line mentioned in the operation S61 does not intersect with an existing segmentation line, this segmentation is valid. Two single-point segmentation lines that do not intersect with each other are illustrated in FIG. 7.

Operation S63: in a case where the single-point segmentation line mentioned in the operation S61 intersects with the existing segmentation line, drawing a perpendicular line from this concave point to the existing segmentation line that intersects with this single-point segmentation line first, and taking this perpendicular line as a single-point segmentation line. The existing segmentation line may include the existing single-point segmentation line and the existing optimal segmentation line.

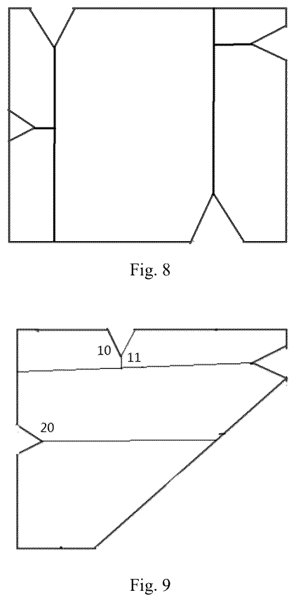

As illustrated in FIG. 8, there are concave points on both the left and right sides. For each concave point, drawing a first perpendicular line from it to its opposite side. This first perpendicular line intersects with an existing segmentation line. At this point, drawing a second perpendicular line from this concave point to the existing segmentation line that intersects with the first perpendicular line first. The second perpendicular line is taken as the single-point segmentation line.

Operation S64: in a case where the perpendicular line mentioned in the operation S61 cannot be found for a certain concave point, performing segmentation along an angle bisector of a concave angle matching this concave point. Taking a line segment obtained by the angle bisector of the concave angle intersecting with the side opposite to the concave angle as the single-point segmentation line. In a case where during the segmentation process, the angle bisector encounters an existing segmentation line, drawing a perpendicular line from this concave point to the existing segmentation line that intersects with the angle bisector first. Taking this perpendicular line as the single-point segmentation line.

As illustrated in FIG. 9, there are certain concave points 10 and 20, for any of whom a segmentation line perpendicular to its opposite side cannot be found. In this case, a segmentation process may be performed along the angular bisector of the entire concave angle for any of the concave points 10 and 20. In a case where the angular bisector encounters the optimal segmentation line or the single-point segmentation line, performing the perpendicular line segmentation process, as illustrated by the perpendicular line segment 11 of FIG. 9. Here, the performing the perpendicular line segmentation process includes: drawing a perpendicular line from the concave point 10 or 20 to the optimal segmentation line or the single-point segmentation line that intersects with the angle bisector first. Taking this perpendicular line as the single-point segmentation line for the concave point 10 or 20.

Operation S65: after segmentation operations for all the concave points are completed, the process ends.

The segmentation priority order in the present disclosure is: (1) the optimal segmentation; (2) the single-point segmentation; and (3) the angular bisector segmentation. By adopting either (1) or (2) alone, a reasonable segmentation of the map may also be achieved. On this basis, for a concave angle that still cannot be reasonably segmented, (3) may be adopted for a supplementary segmentation.

In the present disclosure, constructing the map of the operation area of the self-propelled device, and obtaining the outer boundary map; recognizing inflection points in the outer boundary map, and extracting the feature points from the recognized inflection points; recognizing concave points from the extracted feature points; judging visibility of two concave points, matching visible concave points two by two to generate visible concave-point pairs; performing optimal segmentation according to a relationship between the connection lines of the visible concave-point pairs; and performing a single-point segmentation on the concave points when the optimal segmentation is unable to be performed. In this way, the operation area map of the self-propelled device may be segmented according to the outer boundary. A concave polygon may be segmented into a plurality of convex polygon sub-areas with more regular (squarer) shapes, thereby facilitating a path planning process. The self-propelled device operates in blocks based on sub-areas. In this way, the number of turning times of the self-propelled device during driving may be reduced, the possibility of situations in which the self-propelled device is stuck may be reduced, and the operation efficiency of the self-propelled device may be enhanced. Further, through the area division, shapes of the sub-areas are squarer, thereby increasing the segmentation coverage rate. The problem that an arcuate path of an ox-plowing method cannot cover an entire map is solved.

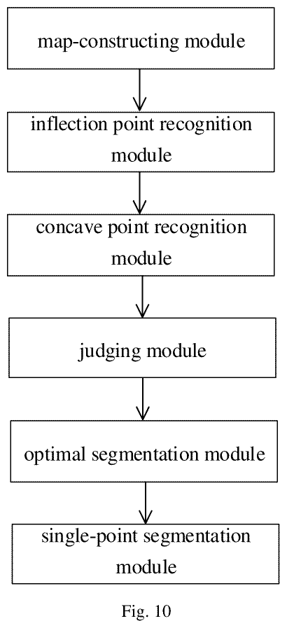

Accordingly, the present disclosure further provides a map area division system for the self-propelled device. As illustrated in FIG. 10, the system includes: a map-constructing module, an inflection point recognition module, a concave point recognition module, a judging module, an optimal segmentation module, and a single-point segmentation module.

The map-constructing module is configured to construct the map of the operation area of the self-propelled device, and obtain the outer boundary map.

The inflection point recognition module is configured to recognize inflection points in the outer boundary map, and extract the feature points from the recognized inflection points.

The concave point recognition module is configured to recognize concave points from the extracted feature points.

The judging module is configured to judge the visibility of two concave points, and match visible concave points two by two to generate the visible concave-point pairs.

The optimal segmentation module is configured to perform the optimal segmentation according to a relationship between the connection lines of the visible concave-point pairs.

The single-point segmentation module is configured to perform, for the concave points on which the optimal segmentation is unable to be performed, the single-point segmentation.

The system in the present embodiment may be configured to execute the technical solution of the method embodiment as illustrated in FIG. 1, whose implementation principle and technical effect are similar, and would not be repeated here.

The embodiments of the present disclosure further provide a self-propelled device. There may be relatively great differences between different self-propelled devices due to different configurations or performances. The self-propelled device may include one or more processors (e.g., central processing units, CPU) and one or more memories. The memory may store at least one instruction. The at least one instruction may be loaded and executed by the processor, so as to implement the operations of the map area division method for the self-propelled device.

In some exemplary embodiments, a computer-readable storage medium is further provided. The computer-readable storage medium may for example be a memory including an instruction. The above-mentioned instruction may be executed by a processor of a terminal device, so as to implement the above-mentioned map area division method for the self-propelled device. For example, the mentioned computer-readable storage medium may be a read-only memory (ROM), a random access memory (RAM), a CD-ROM, a magnetic tape, a floppy disk and an optical data storage device, or the like.

In the present disclosure, the terms “including”, “comprising”, or any other variation thereof are intended to cover non-exclusive inclusion, such that a process, a method, an article or a terminal device including a serial of elements includes not only those elements, but also other elements not expressly listed, or elements inherent to such a process, a method, an article or a terminal device. Without further limitation, an element defined by the statement “including a . . . ” does not preclude the existence of another identical element in the process, the method, the article or the terminal device that includes that element.

In the specification, references to “one embodiment”, “embodiment”, “exemplary embodiment”, “some embodiments” etc., indicate that the embodiments mentioned may include a particular feature, structure or characteristic, but not every embodiment necessarily includes that particular feature, structure or characteristic. In addition, when the particular feature, structure or characteristic is described in conjunction with an embodiment, realization of the feature, structure or characteristic in conjunction with other embodiment (regardless of whether it is explicitly described) shall be within a knowledge scope of those skilled in relevant fields.

The present disclosure covers any substitutions, modifications, equivalent methods and schemes made on the spirit and scope of the present disclosure. To make the public have a thorough understanding of the present disclosure, specific details are illustrated in detail in the embodiments of the present disclosure. However, for those skilled in the art, the present disclosure may be fully understood without these detailed descriptions. In addition, in order to avoid unnecessary confusion to the essence of the present disclosure, well-known methods, processes, flows, elements, circuits, etc. are not illustrated in detail.

Those of ordinary skills in the art may understand that, all or part of the steps in the methods of the above-mentioned embodiments may be completed by instructing relevant hardware through a program. The program may be stored in a computer-readable storage medium, such as a ROM/RAM, a magnetic disk, an optical disk, or the like.

The above-mentioned are merely some embodiments of the present disclosure, and are not intended to restrict the present disclosure. Any modification, equivalent substitution, improvement, or the like made within the spirit and principles of the present disclosure shall be included in the protection scope of the present disclosure.

1. A map area division method applied to a self-propelled device, characterized by comprising:
obtaining an outer boundary map of an operation area of the self-propelled device;
obtaining concave points in the outer boundary map; and
determining concave-point pairs according to visibility of the concave points, and performing an optimal segmentation of the operation area according to a relationship between connection lines of the concave-point pairs;
wherein the connection lines of the concave-point pairs for the optimal segmentation do not intersect with each other.

2. The map area division method as claimed in claim 1, wherein
the obtaining an outer boundary map of an operation area of the self-propelled device comprises:
the self-propelled device walking along the outer boundary of the operation area to obtain a coordinate of each point along the outer boundary, and constructing the outer boundary map.

3. The map area division method as claimed in claim 1, wherein
the obtaining the concave points in the outer boundary map comprises:
recognizing inflection points in the outer boundary map, and obtaining feature points from the recognized inflection points; and
recognizing the concave points from the obtained feature points.

4. The map area division method as claimed in claim 3, further comprising:
comparing adjacent coordinate points in the outer boundary map; and
recognizing inflection points from the two adjacent coordinate points, when the two adjacent coordinate points are in the same row but with different column coordinates, or in the same column but with different row coordinates.

5. The map area division method as claimed in claim 3, further comprising:
obtaining a feature point serves as a concave point, when an included angle of the feature point is greater than 180 degrees, wherein the included angle is inside the map and is formed by outer boundary lines on both sides of the feature point.

6. The map area division method as claimed in claim 1, further comprising:
matching the visible concave points two by two to obtain visible concave-point pairs;
wherein a connection line of the two visible concave points is entirely inside the map.

7. The map area division method as claimed in claim 1, further comprising:
performing a single-point segmentation on the concave points when the optimal segmentation is unable to be performed.

8. The map area division method as claimed in claim 7, wherein
a single-point segmentation line for performing the single-point segmentation does not intersect with an optimal segmentation line for performing the optimal segmentation.

9. A self-propelled device comprising a memory and a processor, the memory storing a computer program capable of running on the processor, wherein
when executing the computer program, the processor is configured to implement a map area division method comprising:
obtaining an outer boundary map of an operation area of the self-propelled device;
obtaining concave points in the outer boundary map; and
determining concave-point pairs according to visibility of the concave points, and performing an optimal segmentation of the operation area according to a relationship between connection lines of the concave-point pairs;
wherein the connection lines of the concave-point pairs for the optimal segmentation do not intersect with each other.

10. A non-volatile computer-readable medium having a program code capable of being executable by a processor, wherein
the program code enables the processor to implement a map area division method comprising:
obtaining an outer boundary map of an operation area of the self-propelled device;
obtaining concave points in the outer boundary map; and
determining concave-point pairs according to visibility of the concave points, and performing an optimal segmentation of the operation area according to a relationship between connection lines of the concave-point pairs;
wherein the connection lines of the concave-point pairs for the optimal segmentation do not intersect with each other.

11. The self-propelled device as claimed in claim 9, wherein
the obtaining an outer boundary map of an operation area of the self-propelled device comprises:
the self-propelled device walking along the outer boundary of the operation area to obtain a coordinate of each point along the outer boundary, and constructing the outer boundary map.

12. The self-propelled device as claimed in claim 9, wherein
the obtaining the concave points in the outer boundary map comprises:
recognizing inflection points in the outer boundary map, and obtaining feature points from the recognized inflection points; and
recognizing the concave points from the obtained feature points.

13. The self-propelled device as claimed in claim 12, wherein
the map area division method further comprises:
obtaining a feature point serves as a concave point, when an included angle of the feature point is greater than 180 degrees, wherein the included angle is inside the map and is formed by outer boundary lines on both sides of the feature point.

14. The self-propelled device as claimed in claim 9, wherein
matching the visible concave points two by two to obtain visible concave-point pairs;
wherein a connection line of the two visible concave points is entirely inside the map.

15. The self-propelled device as claimed in claim 9, wherein
the map area division method further comprises:
performing a single-point segmentation on the concave points when the optimal segmentation is unable to be performed; and
a single-point segmentation line for performing the single-point segmentation does not intersect with an optimal segmentation line for performing the optimal segmentation.

16. The computer-readable medium as claimed in claim 10, wherein
the obtaining an outer boundary map of an operation area of the self-propelled device comprises:
the self-propelled device walking along the outer boundary of the operation area to obtain a coordinate of each point along the outer boundary, and constructing the outer boundary map.

17. The computer-readable medium as claimed in claim 10, wherein
the obtaining the concave points in the outer boundary map comprises:
recognizing inflection points in the outer boundary map, and obtaining feature points from the recognized inflection points; and
recognizing the concave points from the obtained feature points.

18. The computer-readable medium as claimed in claim 17, wherein
the map area division method further comprises:
obtaining a feature point serves as a concave point, when an included angle of the feature point is greater than 180 degrees, wherein the included angle is inside the map and is formed by outer boundary lines on both sides of the feature point.

19. The computer-readable medium as claimed in claim 10, wherein
matching the visible concave points two by two to obtain visible concave-point pairs;
wherein a connection line of the two visible concave points is entirely inside the map.

20. The computer-readable medium as claimed in claim 10, wherein
the map area division method further comprises:
performing a single-point segmentation on the concave points when the optimal segmentation is unable to be performed; and
a single-point segmentation line for performing the single-point segmentation does not intersect with an optimal segmentation line for performing the optimal segmentation.
